(19) United States
(12) Patent Application Publication
(10) Pub. No.: US 2012/0041730 A1
(43) Pub. Date: Feb. 16, 2012

(54) POWER-SUPPLY DESIGN SYSTEM, POWER-SUPPLY DESIGN METHOD, AND PROGRAM FOR POWER-SUPPLY DESIGN

(76) Inventor: Manabu Kusumoto, Tokyo (JP)

(21) Appl. No.: 13/262,954

(22) PCT Filed: Apr. 12, 2010
(86) PCT No.: PCT/JP2010/002638

§ 371 Date: Oct. 11, 2011

(30) Foreign Application Priority Data
May 1, 2009 (JP) 2009-112063

(51) Int. Cl. G06F 17/50

(52) U.S. Cl. 703/2

(57) ABSTRACT

Provided is a power-supply design system that supports a power-supply design by applying a random model based on an outline of an operation circuit of an electronic device to calculate a value representing a power-supply fluctuation with a statistical technique, and by outputting a statistical value representing the power-supply fluctuation. The power-supply design system calculates a statistical value representing a power-supply fluctuation in a power supply of an electronic device based on input design data of the electronic device and a random model representing a current fluctuation due to operation/non-operation of each circuit in the electronic device, and outputs the statistical value.

### TECHNICAL FIELD

The present invention relates to a power-supply design system, a power-supply design method, and a program for a power-supply design that are used as tools for designing a power supply of electronic equipment or an electronic device (hereinafter referred to as “an electronic device”).

More particularly, the present invention relates to a power-supply design system, a power-supply design method, and a program for a power-supply design that support a power-supply design in an upstream process of a design stage by applying a random model based on an outline of an operation circuit provided in an electronic device and outputting a statistical value representing a power-supply fluctuation.

### BACKGROUND ART

In recent years, high performance and high speed operations of electronic devices including large scale integration (LSI) and the like have been implemented along with the rapid development of semiconductor technology. Thus, costs required to design and verify a power supply of an electronic device has also increased. To reduce the cost of designing the power supply of the electronic device, the verification of the electronic device using a simulation in a design stage is actively performed. It is possible to determine the quality, problems, or the like of a design of the power supply in the electronic device by analyzing a result of verification using the above-described simulation. Thereby, it is possible to solve a problem in that the power supply should be re-designed after building a prototype of the electronic device. Therefore, it is possible to reduce the cost of designing the power supply in the electronic device.

Additionally, various technologies for supporting a design of a power supply of an electronic device by use of a simulation have been disclosed. For example, technology for supporting the design by pre-obtaining an impedance of a power supply by use of a simulation and by determining the presence/absence of resonance of the power supply based on the obtained impedance so as to eliminate a multipath fading phenomenon in which received waves are degraded when multiplexed waves via a plurality of propagation paths interfere with each other has been disclosed (for example, see Patent Document 1). Also, technology for supporting the design by adjusting a simulation model based on a measured result of a power-supply circuit of an electronic device has been disclosed (for example, see Patent Document 2). Furthermore, technology for appropriately supporting the design by generating an analysis model from a high volume of design information for an electronic device and determining decoupling capacitance for arranging a capacitor in a power-supply circuit, which is an important element for designing a power supply, has been disclosed (see Patent Document 3).

Moreover, it is very important to suppress a fluctuation of a power-supply voltage in the power-supply design of the electronic device. That is, current flows from a power supply when an operation unit of the electronic device performs various operations. At this time, the operation unit of the electronic device includes LSI and many other electronic components, and various circuits of the electronic device are operated or stopped in accordance with operation states of the respective electronic components. Along with this, the current flowing through the operation unit varies depending on the number of circuits operating at each timing. Accordingly, the fluctuation of the power-supply voltage occurs along with the variation of the current. Thus, an optimum power supply is designed so that a stable power-supply voltage can be implemented by analyzing the fluctuation of the power-supply voltage accompanying the variation of the current.

### Prior Art Document

### Patent Document

Patent Document 1: Japanese Patent No. 3609305
Patent Document 2: Japanese Unexamined Patent Application, First Publication No. 2007-133484
Patent Document 3: Japanese Unexamined Patent Application, First Publication No. 2008-70924

### DISCLOSURE OF INVENTION

### Problems to be Solved by the Invention

However, it is very difficult to perform a design using a simulation in the upstream process of the design in which a detailed operation state of the electronic device is not determined. Therefore, the simulation is performed based on detailed design data, or the simulation is performed after measurement data is obtained once using an actual electronic device as in the technology of Patent Document 2 described above. However, it is not possible to gather information necessary for the simulation in the upstream process of the design. Thus, an appropriate simulation is not currently performed in the upstream process of the design in which a design using the simulation is effective.

Moreover, since an actual electronic device performs a complex operation, it is very difficult to perform a simulation in which an operation of the electronic device is accurately simulated. That is, in order to simulate a variation state of a current accompanying an actual complex operation in the electronic device, a large amount of calculation is necessary to analyze a result of the simulation because a simulation model itself is significantly complex. Therefore, currently, the simulation is performed by assuming the iteration of a simple operation or the like. Thus, the power supply is designed in a state in which only a few operations in the electronic device can be considered without consideration of, for example, a phenomenon occurring at a low frequency in the electronic device. Accordingly, it is not possible to design a high-quality power supply. It is to be noted that even in aforementioned Patent Documents 1, 2, and 3, it is not possible to design a high-quality power supply because the simulation is not performed in consideration of all operations of the electronic device.

The present invention has been made in view of the above-described problems, and an exemplary object thereof is to provide a power-supply design system, a power-supply design method, and a program for a power-supply design that support the power-supply design by outputting a statistical value representing a power-supply fluctuation using a simulation in which a random model based on an outline of an operation of an electronic device is applied and a calculation is carried out with a statistical technique in an upstream process of a design stage.

### Means for Solving the Problems

In order to achieve the above-described exemplary object, a power-supply design system in accordance with the present invention includes: an input device that inputs design data of an electronic device; a storage device that stores a random model representing a current fluctuation due to operation/non-operation of each circuit in the electronic device; a statistical value calculation device that calculates a statistical value representing a power-supply fluctuation in a power supply of the electronic device based on the design data and the random model; and an output device that outputs the statistical value representing the power-supply fluctuation.

Moreover, a power-supply design method in accordance with the present invention inputs design data of an electronic device; calculates a statistical value representing a power-supply fluctuation in a power supply of the electronic device based on the design data and a random model representing a current fluctuation due to operation/non-operation of each circuit in the electronic device; and outputs the statistical value representing the power-supply fluctuation.

### Effects of the Invention

In accordance with the present invention, it is possible to obtain information on a level of a power-supply fluctuation of an electronic device such as a voltage fluctuation from a statistical value representing the power-supply fluctuation (for example, a standard deviation, which is one of statistical indices). As a result, it is possible to acquire a predicted value of a value related to the power-supply fluctuation such as a voltage fluctuation value. For example, in the present invention, a current variation (that is, a current deviation) is obtained with a statistical technique under an assumption that a mode of operation/non-operation of each of various circuits of the electronic device is a mode randomly operating at a constant probability. For example, a voltage variation (that is, a voltage deviation) is then calculated based on the current deviation and an impedance obtained from a circuit constant. Furthermore, for example, a voltage fluctuation range (voltage deviation) is assumed to follow a normal distribution, and a power-supply design is studied based on a probability at which it exceeds a constant voltage fluctuation range by use of a standard deviation. By adopting such a technique, it is possible to design the power supply at a proper cost without verification using a simulation based on detailed design data. Therefore, it is possible to reduce the cost of designing the power supply in the electronic device.

### BRIEF DESCRIPTION OF THE DRAWINGS

FIG. 1 is a block diagram showing the configuration of a power-supply design system in accordance with a first exemplary embodiment of the present invention.

FIG. 2 is an equivalent circuit diagram showing a power-supply wiring model applied to the power-supply design system shown in FIG. 1.

FIG. 3A is an equivalent circuit diagram of an example of a component on a power supply applied to the power-supply design system shown in FIG. 1, the equivalent circuit diagram representing a capacitor model.

FIG. 3B is an equivalent circuit diagram of another example of a component on the power supply applied to the power-supply design system shown in FIG. 1, the equivalent circuit diagram representing an inductor model.

FIG. 4 is a block diagram showing the configuration of a power-supply design system in accordance with a second exemplary embodiment of the present invention.

FIG. 5 is a block diagram showing the configuration of a power-supply design system in accordance with a third exemplary embodiment of the present invention.

FIG. 6 is a block diagram of a fourth exemplary embodiment in which the power-supply design system in accordance with the present invention is configured using a program.

FIG. 7 is a flowchart showing an example of a specific operation performed by a current deviation calculation unit 201 shown in FIG. 5.

FIG. 8 is a flowchart showing an example of a specific operation performed by an impedance calculation unit 202 shown in FIG. 5.

FIG. 9 is an impedance characteristic diagram applied to an example of the present invention.

FIG. 10 is an impedance characteristic diagram re-calculated based on impedance characteristics of FIG. 9.

### MODE FOR CARRYING OUT THE INVENTION

Hereinafter, some exemplary embodiments of a power-supply design system in accordance with the present invention will be described in detail with reference to the drawings. It is to be noted that in all the drawings for describing the respective exemplary embodiments, the same elements are denoted by the same reference symbols, as a principle, and the repeated description thereof is omitted.

### First Exemplary Embodiment

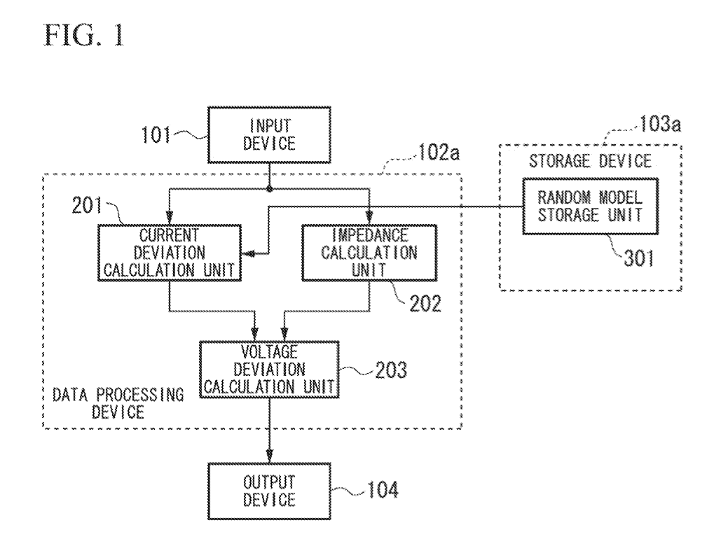

FIG. 1 is a block diagram showing the configuration of a power-supply design system in accordance with the first exemplary embodiment of the present invention. As shown in FIG. 1, the power-supply design system is configured by an input device 101 implemented using a keyboard, a mouse, or the like, a data processing device 102a operating under the control of various programs, a storage device 103a for storing various pieces of information, and an output device 104 implemented using a display device, a print device, or the like.

The input device 101 is a device that inputs, as design data, operation circuit information such as consumption current, the number of transistors, or the like of various circuits of a power supply in an electronic device as well as power-supply circuit information on arrangement of components such as a power-supply wiring pattern and capacitors. Additionally, the storage device 103a is a database storing various data, and includes a random model storage unit 301. The random model storage unit 301 is a database that pre-stores data for enabling a current deviation calculation unit 201 to be described later to generate a random model based on the operation circuit information input from the input device 101.

The data processing device 102a includes the current deviation calculation unit 201, an impedance calculation unit 202, and a voltage deviation calculation unit 203.

The current deviation calculation unit 201 configures a random model of current by accessing the random model from the random model storage unit 301 based on the operation circuit information (for example, a consumption current, the number of transistors, or the like) input from the input device 101, and calculates a standard deviation (current deviation) of a current fluctuation.

The impedance calculation unit 202 calculates an impedance of a power-supply circuit based on the power-supply circuit information (for example, arrangement of components such as a power-supply wiring pattern and capacitors) input from the input device 101.

The voltage deviation calculation unit 203 calculates a standard deviation (voltage deviation) of a voltage fluctuation based on the standard deviation of the current fluctuation calculated by the current deviation calculation unit 201 and the impedance of the power-supply circuit calculated by the impedance calculation unit 202. The output device 104 outputs the standard deviation (voltage deviation) of the voltage fluctuation calculated by the voltage deviation calculation unit 203.

Next, the overall operation of the power-supply design system in accordance with the present exemplary embodiment will be described in detail with reference to FIG. 1. Data of the power supply in the electronic device input from the input device 101 (or the operation circuit information, the power-supply circuit information, or the like described above) is given to the current deviation calculation unit 201 and the impedance calculation unit 202 in the data processing device 102a.

The current deviation calculation unit 201 then calculates a standard deviation (current deviation) of a current fluctuation by applying a random model to the current fluctuation by use of conditions (operation circuit information) of an operation circuit input from the input device 101. For example, when the consumption current and the number of operation blocks are given as the conditions of the operation circuit, the current deviation calculation unit 201 applies a random model of a binomial distribution in which the operation blocks respectively take two types of operation/non-operation states at a constant probability to the current fluctuation, and obtains a standard deviation of the binomial distribution. Specifically, the current deviation calculation unit 201 obtains a standard deviation σᵢ of the current fluctuation in accordance with the following Equation (1).

[Equation 1]

σᵢ=i_{b}\sqrt{np(1−p)} (1)

Here, σᵢ is the standard deviation of the current fluctuation, i_{b} is the current when one block of the circuit operates, n is the number of the operation blocks, and p is a probability at which the operation block operates.

Moreover, as another example of the conditions of the operation circuit, there is a current fluctuation iₐ. When the current fluctuation iₐ is given, it is possible to obtain the standard deviation σᵢ of the current fluctuation in accordance with the following Equation (2) by assuming a random model in which current uniformly varies within a range of the current fluctuation iₐ.

$$\begin{matrix}[ Equation 2 ] & \\ {σ}_{i} = \frac{{i}_{a}}{\sqrt{3}} & ( 2 )\end{matrix}$$

Next, the impedance calculation unit 202 calculates an impedance of the power supply (for example, an impedance characteristic z(f) when a frequency is f) based on the input power-supply circuit information. The impedance calculation unit 202 calculates the impedance based on, for example, information on a layout of the power-supply circuit included in the power-supply circuit information.

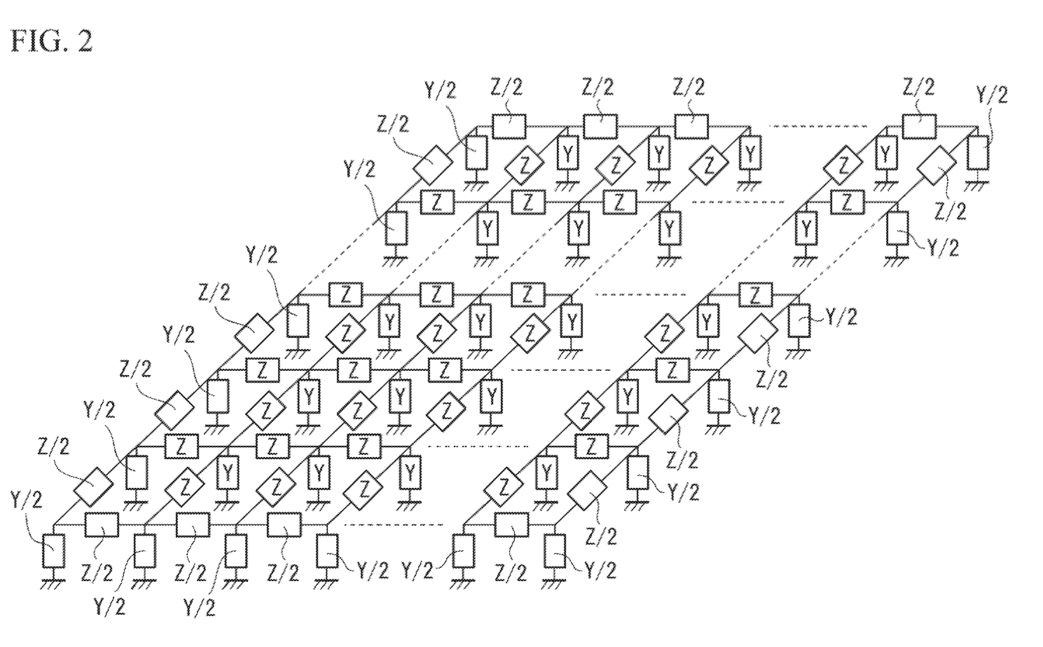

FIG. 2 is an equivalent circuit diagram showing a power-supply wiring model applied to the power-supply design system shown in FIG. 1. For example, the impedance calculation unit 202 transforms a power-supply wiring pattern into an equivalent circuit as shown in FIG. 2, and calculates an impedance by use of a circuit simulator. It is to be noted that a number of impedances Z and Z/2 and a number of conductances Y and Y/2 are distributed in the equivalent circuit representing the power-supply wiring model, as shown in FIG. 2.

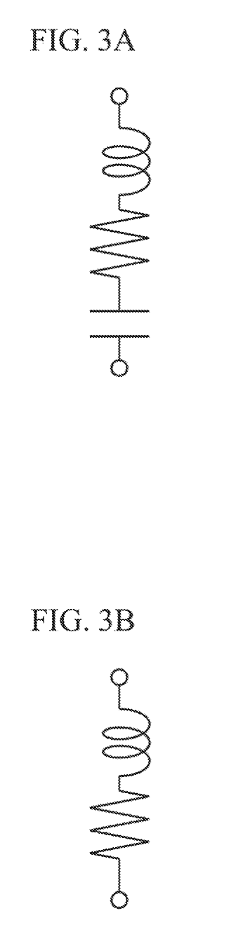

Moreover, FIGS. 3A and 3B are equivalent circuit diagrams in examples of components in the power supply applied to the power-supply design system shown in FIG. 1. FIG. 3A shows a capacitor model, and FIG. 3B shows an inductor model. That is, for example, the impedance calculation unit 202 transforms a capacitor and an inductor into the equivalent circuits as shown in FIGS. 3A and 3B, respectively, and calculates the impedances by use of a circuit simulator.

Next, the voltage deviation calculation unit 203 calculates a standard deviation σᵥ of a voltage fluctuation in accordance with the following Equation (3) based on the standard deviation σᵢ of the current fluctuation calculated by the current deviation calculation unit 201 and the impedance characteristic z(f) at the frequency f calculated by the impedance calculation unit 202.

$$\begin{matrix}[ Equation 3 ] & \\ \frac{{σ}_{v}}{{σ}_{i}} = \sqrt{\frac{{\int }_{0}^{{f}_{a}} {Z ( f )}^{2} d f}{{f}_{a}}} & ( 3 )\end{matrix}$$

Here, fₐ is the value of a frequency corresponding to half a frequency at which current varies.

The output device 104 then outputs the standard deviation σᵥ of the voltage fluctuation calculated with the above-described Equation (3) or a voltage fluctuation value and a probability thereof when a normal distribution is applied to the voltage fluctuation, and notifies a designer of the power supply of information indicating how much the voltage fluctuates.

That is, in accordance with the power-supply design system of the present exemplary embodiment, it is possible to obtain information indicating how much the voltage fluctuates from the standard deviation, which is one of statistical indices, and consequently acquire a predicted value of a voltage fluctuation value. In other words, unlike a power-supply design system adopting a design method based on a voltage fluctuation value, the power-supply design system of the present exemplary embodiment performs a design based on a standard deviation using a statistical technique.

At this time, the impedance of the power supply and information a current variation in an operation unit of the electronic device are important in obtaining a voltage fluctuation of the power supply by analyzing a result of verification using a simulation. The current flows due to operations of various circuits in the operation unit of the electronic device. The current varies with an amount of a temporal variation of an operation/non-operation of each of the various circuits.

However, the operation/non-operation of each of the various circuits is a very complex mode because it is determined by a plurality of closely related circuits. Thus, a large amount of calculation is necessary to obtain a variation of a current based on the operations of the various circuits. Moreover, because a circuit operation cannot be obtained in the upstream process of the design in which a detailed circuit operation is not determined, it is not possible to obtain the variation of the current based on the circuit operation.

Accordingly, in the power-supply design system of the present exemplary embodiment, the variation of the current is obtained by assuming that the operation/non-operation of each of the various circuits is a mode randomly operating at a constant probability. At this time, in order to express various circuits operating at random, a range of a fluctuation of a consumption current depending on a variation of the number of operation circuits is expressed by a standard deviation (current deviation) of a current fluctuation by use of a statistical technique. That is, it can be seen that a relational expression of the standard deviation σᵥ of the voltage fluctuation, the standard deviation σᵢ of the current fluctuation, and the impedance characteristic z(f) at the frequency f can be obtained by the above-described Equation (3).

That is, as seen from the above-described Equation (3), when the current fluctuates at random, the standard deviation σᵥ or the voltage fluctuation becomes a product of the standard deviation σᵢ of the current fluctuation and a value obtained by calculating the square root of a frequency average of the square of the impedance characteristic z(f).

This results from the fact that when the current fluctuates at random, its frequency characteristics spreading throughout a frequency band. That is, it is possible to obtain a temporal fluctuation of a voltage by transforming a temporal fluctuation of the current into a frequency characteristic, multiplying a frequency characteristic of the impedance by the transformed frequency characteristic, and restoring a multiplied result to a time waveform. As a result of estimation and study from these, it can be seen that a relationship between the standard deviation σᵥ of the voltage fluctuation and the standard deviation σᵢ of the current fluctuation becomes a relationship similar to the above-described Equation (3).

Here, a power-supply design is examined by using a target range of the voltage fluctuation as the standard deviation σᵥ of the voltage fluctuation. That is, it is aimed at reducing the voltage fluctuation within a constant value as a target level of the voltage fluctuation. However, in practice, it is very difficult to reduce the voltage fluctuation within the constant value in all conditions. Moreover, high cost is required to reduce the voltage fluctuation within the constant value. Furthermore, a level of the voltage fluctuation to be reduced differs depending on cost available to a target electronic device. Therefore, as a result of study, it has been concluded that a power supply can be designed at proper cost if the power-supply design is considered using a probability at which the voltage fluctuation exceeds a constant voltage fluctuation range based on the standard deviation σᵥ of the voltage fluctuation assuming that the range of the voltage fluctuation follows a normal distribution.

### Second Exemplary Embodiment

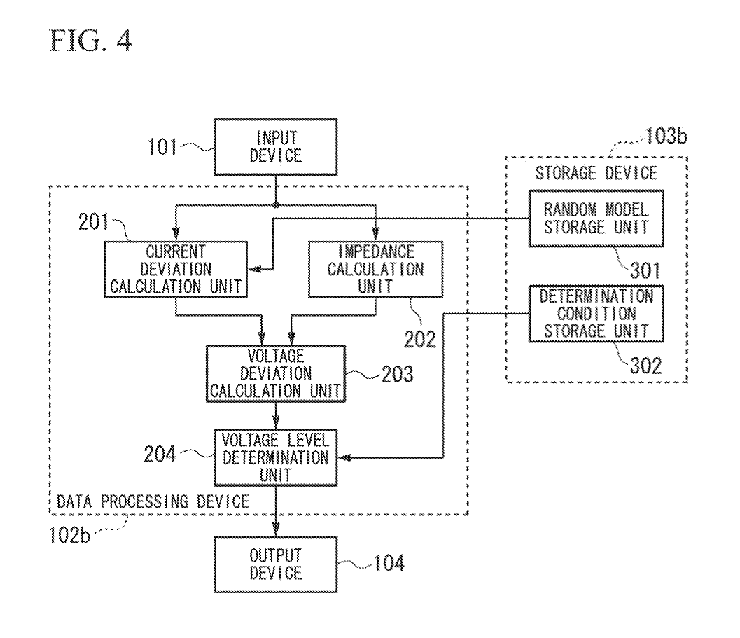

FIG. 4 is a block diagram showing the configuration of a power-supply design system in accordance with the second exemplary embodiment of the present invention. In the power-supply design system of the second exemplary embodiment, as compared to the power-supply design system of the first exemplary embodiment shown in FIG. 1 described above, a voltage level determination unit 204 is added to a data processing device 102b and a determination condition storage unit 302 is added to a storage device 103b as shown in FIG. 4. The determination condition storage unit 302 stores a determination condition defining a predetermined range (a design level range) for determination as to whether or not a voltage fluctuation range stochastically falls within the predetermined range, as a determination database.

That is, the voltage level determination unit 204 determines whether or not the voltage fluctuation range stochastically falls within the predetermined range based on the standard deviation of the voltage fluctuation calculated by the voltage deviation calculation unit 203 and information of the determination database of the determination condition storage unit 302 in the storage device 103b. The output device 104 then outputs a determination result. Thereby, it is possible to obtain a more direct determination result of the voltage fluctuation than the index of the standard deviation of the voltage fluctuation. Thus, it is possible to more effectively support a design because the designer can more easily understand information on a voltage fluctuation serving as a design factor.

### Third Exemplary Embodiment

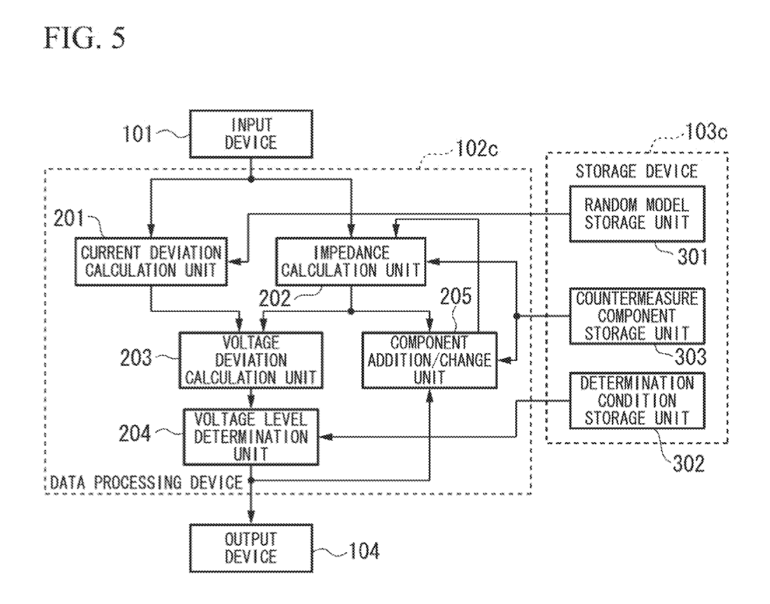

FIG. 5 is a block diagram showing the configuration of a power-supply design system in accordance with the third exemplary embodiment of the present invention. In the power-supply design system of the third exemplary embodiment, as compared to the above-described power-supply design system of the second exemplary embodiment shown in FIG. 4, a component addition/change unit 205 is added to a data processing device 102c and a countermeasure component storage unit 303 is added to a storage device 103c as shown in FIG. 5. The countermeasure component storage unit 303 stores characteristics (component data) of respective power-supply components.

That is, when the result of determining whether or not the voltage fluctuation range is in the predetermined range is negative (that is, when the voltage fluctuation range is not in the predetermined range), the voltage level determination unit 204 notifies the component addition/change unit 205 of information indicating that fact. Thereby, the component addition/change unit 205 selects a component from the countermeasure component storage unit 303 of the storage device 103c based on the impedance calculation result of the impedance calculation unit 202, and adds the selected component to a power-supply circuit.

For example, the component addition/change unit 205 searches for a frequency at which the impedance has a peak based on the impedance calculation result output from the impedance calculation unit 202, identifies a capacitor suitable for the frequency from the countermeasure component storage unit 303, and adds the identified capacitor to the power-supply circuit. The component addition/change unit 205 then notifies the impedance calculation unit 202 of information on the power-supply circuit to which the component (capacitor) is added. Based on this information, the impedance calculation unit 202 re-calculates the impedance, the voltage deviation calculation unit 203 re-calculates the standard deviation of the voltage fluctuation, and the voltage level determination unit 204 re-determines whether or not the voltage fluctuation range is in the predetermined range.

Here, when the determination result of the voltage level determination unit 204 is positive (that is, when the voltage fluctuation range is in the predetermined range), information on the power-supply circuit of the electronic device corresponding to a positive condition is output from the output device 104. Thereby, it is possible to automatically support the design of the power supply for the designer.

It is to be noted that as described above, a countermeasure component is added to the power-supply circuit so that the voltage fluctuation range is in the predetermined range. However, for example, a specific component in the power-supply circuit may be changed (that is, a specific component may be replaced with a countermeasure component) so that the voltage fluctuation range is in the predetermined range.

### Fourth Exemplary Embodiment

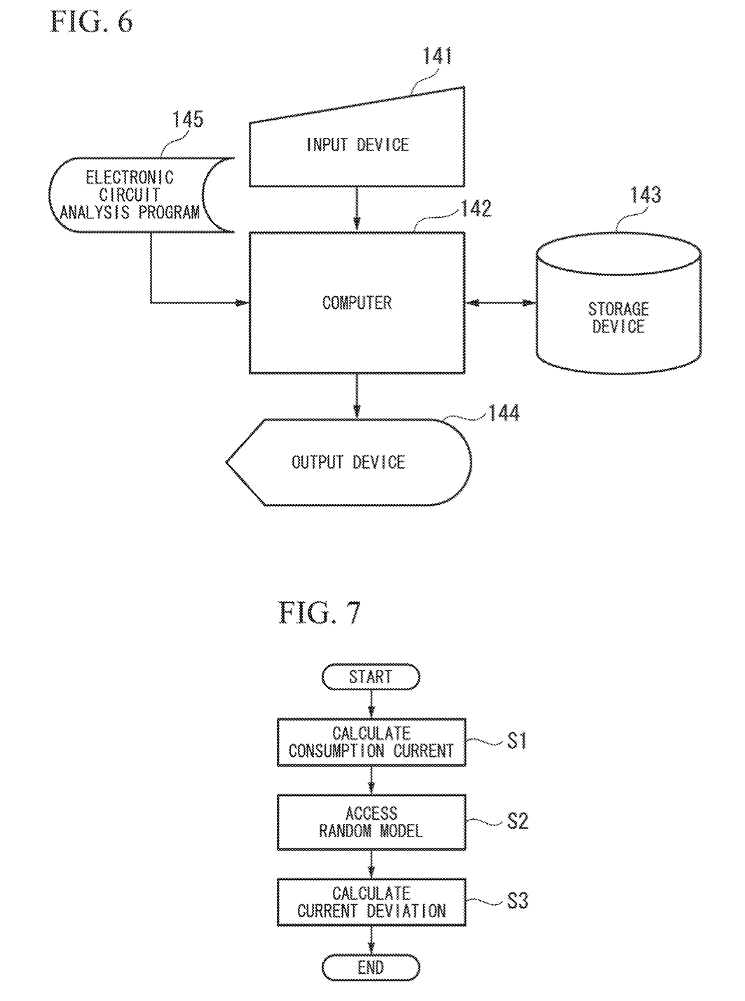

FIG. 6 is a block diagram of the fourth exemplary embodiment in which the power-supply design system in accordance with the present invention is configured using a program. That is, FIG. 6, which shows the power-supply design system of the fourth exemplary embodiment, is a diagram showing a program and the configuration of a computer operating in accordance with the program when the power-supply design systems of the first, second, and third exemplary embodiments shown in FIGS. 1, 4, and 5 described above are configured using the program.

The power-supply design system shown in FIG. 6 includes an input device 141, a computer (a central processing unit or a processor) 142, a storage device 143, an output device 144, and an electronic circuit analysis program 145.

That is, for example, a program input from the input device 141 is read in the computer 142 for implementing the function of the data processing device 102a of FIG. 1, and an operation of the computer 142 is controlled. Furthermore, the electronic circuit analysis program 145 is read in the computer 142, and the computer 142 generates information having the same content as the storage devices 103a, 103b, and 103c in accordance with the above-described first to third exemplary embodiments while operating the storage device 143. Moreover, the computer 142 executes the same process as those performed by the data processing devices 102a, 102b, and 102c of the above-described first to third exemplary embodiments in accordance with control of the electronic circuit analysis program 145.

### Examples

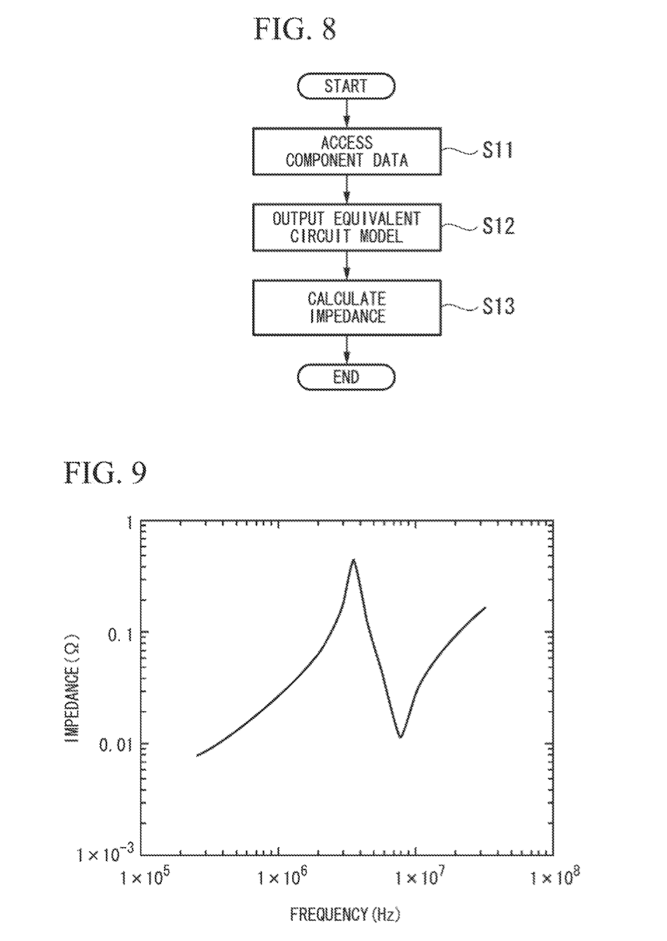

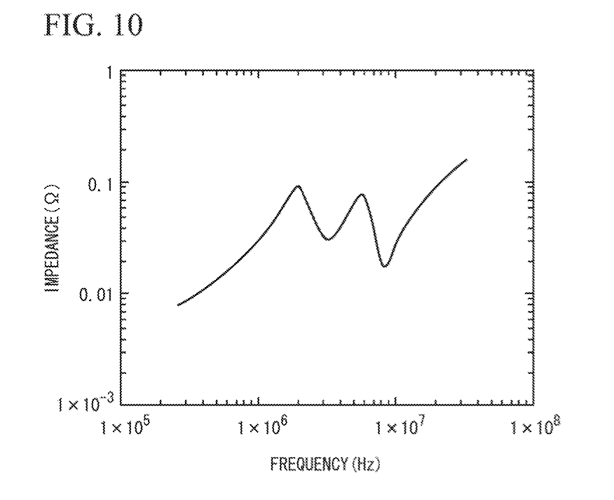

Next, an example of a specific operation of the power-supply design system will be described using FIGS. 7, 8, 9, and 10 with reference to FIG. 5 as an example. It is to be noted that FIG. 7 is a flowchart showing an example of a specific operation performed by the current deviation calculation unit 201 shown in FIG. 5. FIG. 8 is a flowchart showing an example of a specific operation performed by the impedance calculation unit 202 shown in FIG. 5. FIG. 9 is an impedance characteristic diagram applied to an example of the present invention. FIG. 10 is an impedance characteristic diagram re-calculated based on the impedance characteristics of FIG. 9. It is to be noted that in FIGS. 9 and 10, the horizontal axis represents a frequency (Hz), and the vertical axis represents an impedance (Ω).

First, in FIG. 5, an operation voltage (1.2 V) of LSI, consumption power (12 W), an operation frequency (128 MHz), the number of circuits (one million), and an operation rate (0.5) are input from the input device 101 as an example of operation circuit information. Moreover, information on capacitors connected to the power supply is input from the input device 101 as an example of power-supply circuit information. For example, the information on the capacitors is information indicating that five capacitors of 0.1 μF and two capacitors of 100 μF are connected to the power supply.

Next, as shown in the flowchart of FIG. 7, the current deviation calculation unit 201 of the data processing device 102c calculates a current deviation. That is, the current deviation calculation unit 201 obtains a consumption current per circuit (step S1). At this time, the current deviation calculation unit 201 obtains the consumption current (10 A) by dividing the consumption power (12 W) by the operation voltage (1.2 V). Furthermore, the current deviation calculation unit 201 obtains the consumption current per circuit (20 μA) by dividing the consumption current (10 A) by the number of operations (half a million), which is obtained by multiplying the operation rate (0.5) by the number of circuits (one million).

The current deviation calculation unit 201 then accesses a random model from the random model storage unit 301 of the storage device 103c based on given parameters (that is, the operation circuit information input from the input device 101) (step S2). In this example, it is assumed that a binomial distribution is accessed as the random model. Thereafter, the current deviation, that is, the standard deviation σᵢ (0.01 A) of the current fluctuation, is obtained by substituting the number of circuits (that is, the number of operation blocks, n=one million), the operation rate (p=0.5), and the consumption current per circuit (i_{b}=20 μA) into Equation (1) (step S3). That is, σᵢ=20×10⁻⁶ (10⁶×0.5×0.5)^{1/2}=0.01 A is obtained.

Next, the impedance calculation unit 202 of the data processing device 102c calculates the impedance as shown in the flowchart of FIG. 8. That is, the impedance calculation unit 202 accesses characteristics (component data) of respective power-supply components, which are the power-supply circuit information input from the input device 101, from the countermeasure component storage unit 303 of the storage device 103c (step S11). Next, the impedance calculation unit 202 generates and outputs an equivalent circuit model based on data of the respective power-supply components (countermeasure components) accessed from the countermeasure component storage unit 303 (step S12). The impedance calculation unit 202 then calculates the impedance based on the generated equivalent circuit model (step S13).

The calculation result of the impedance calculated by the impedance calculation unit 202 indicates that an impedance value differs depending on a frequency as shown in FIG. 9.

Next, the voltage deviation calculation unit 203 of the data processing device 102c calculates the voltage deviation (that is, the standard deviation σᵥ of the voltage fluctuation). That is, the voltage deviation (the standard deviation σᵥ of the voltage fluctuation) is calculated by substituting the current deviation (the standard deviation σᵢ=0.01 A of the current fluctuation) obtained in step S3 of FIG. 7 and the impedance obtained in step S13 of FIG. 8 into the above-described Equation (3). Thereby, the voltage deviation (the standard deviation of the voltage fluctuation) σᵥ=11.4 mV is obtained.

Next, the voltage level determination unit 204 of the data processing device 102c determines whether or not the voltage fluctuation range is in the predetermined range. At this time, the voltage level determination unit 204 accesses the determination condition from the determination database of the determination condition storage unit 302 of the storage device 103c. In this example, the voltage level determination unit 204 accesses 9.8 mV, which is a condition that it is included within 5% of an input voltage 1.2 V at a probability of 10⁻⁹, as a determination condition based the an input voltage (operation voltage).

Here, in this example, the calculated voltage deviation (the standard deviation σᵥ of the voltage fluctuation) is 11.4 mV, which is greater than the determination condition 9.8 mV of the voltage fluctuation range. Thus, the voltage level determination unit 204 determines that the voltage fluctuation range is not in the predetermined range and generates negative information as a determination result with respect to the voltage fluctuation range.

Next, the component addition/change unit 205 of the data processing device 102c adds a component to the power-supply circuit because the determination result of the voltage fluctuation range is negative. That is, the component addition/change unit 205 selects a component (for example, a capacitor of 1 μF) effective around a frequency of 3.2 MHz (3.2×10⁶ Hz) at which the impedance has a peak based on the calculation result of the impedance shown in the impedance characteristic diagram of FIG. 9, and adds it to the power-supply circuit.

Next, the impedance calculation unit 202 of the data processing device 102c re-calculates the impedance of the power-supply circuit to which the capacitor of 1 μF is added. The impedance calculation result is shown in FIG. 10.

Next, the voltage deviation calculation unit 203 of the data processing device 102e re-calculates the voltage deviation (the standard deviation σᵥ of the voltage fluctuation) in accordance with Equation (3) based on the value of the re-calculated impedance. At this time, the voltage deviation (the standard deviation σᵥ of the voltage fluctuation) is 8.9 mV.

Next, the voltage level determination unit 204 of the data processing device 102c determines whether or not the voltage fluctuation range is in the predetermined range. At this time, because the determination condition of the voltage fluctuation range is 9.8 mV and the voltage deviation (the standard deviation σᵥ of the voltage fluctuation) is 8.9 mV, the voltage deviation 8.9 mV satisfies a determination criterion. Thus, the voltage level determination unit 204 outputs positive information as the determination result of the voltage fluctuation range.

Finally, information on the power-supply circuit (for example, information indicating five capacitors of 0.1 μF, one capacitor of 1 μF, and two capacitors of 100 μF) for which the positive information is obtained is then output from the output device 104. Accordingly, it is possible to appropriately support a design for the designer based on such power-supply circuit information.

While the present invention has been particularly shown and described with reference to exemplary embodiments and examples thereof, the present invention is not limited to these exemplary embodiments and examples. It will be understood by those of ordinary skill in the art that various changes in form and details may be made therein without departing from the spirit and scope of the present invention as defined in the claims.

It is to be noted that the power-supply design method described above with reference to FIGS. 7 and 8 can be executed by a computer reading a program and executing the program. For example, each processing step of the above-described power-supply design method is stored in a computer-readable recording medium in the form of a program, and the above-described process is performed by the computer reading and executing the program. Here, the computer-readable recording medium is a magnetic disk, a magneto-optical disc, a compact disc read-only memory (CD-ROM), a digital versatile disc (DVD)-ROM, a semiconductor memory, or the like. Moreover, the program may be distributed to an external computer via a communication line, and the computer receiving the distribution may execute the program.

Additionally, the above-described program may implement part of the function of the above-described power-supply design method. In addition, the program may be a so-called differential file (differential program) capable of implementing the function of the above-described power-supply design method in combination with a program already recorded in a computer system.

As described above, a power-supply design system has performed a design by executing a simulation using detailed design data. Thus, it was not possible to collect information necessary for the simulation in an upstream process of a design stage in which an operation of an electronic device is undecided. Therefore, it was not possible to perform an appropriate simulation in the upstream process of the design stage in which the design using the simulation is particularly effective.

In contrast, the power-supply design system in accordance with the exemplary embodiments and examples of the present invention obtain a standard deviation of a current fluctuation of an electronic device by applying a random model to the current fluctuation, and predicts a standard deviation of a voltage fluctuation based on a relationship with an impedance of a power supply calculated separately. Thereby, it is possible to design the power supply by use of the standard deviation of the voltage fluctuation, which is statistical data. Thus, it is possible to appropriately design the power supply by analyzing the standard deviation of the voltage fluctuation even in the upstream process of the design in which there is no detailed information.

This application is based upon and claims the benefit of priority from Japanese Patent Application No. 2009-112063, filed May 1, 2009, the disclosure of which is incorporated herein in its entirety by reference.

### INDUSTRIAL APPLICABILITY

In accordance with a power-supply design system of the present invention, when a power supply of an electronic device is designed, it can be effectively used in a program for causing a computer to implement an auxiliary device or automatic design device for a power-supply design, or the like.

### DESCRIPTION OF REFERENCE SYMBOLS

101, 141: Input device
102a, 102b, 102c: Data processing device (statistical value calculation device)
103a, 103b, 103c, 143: Storage device
104, 144: Output device
142: Computer
145: Electronic circuit analysis program
201: Current deviation calculation unit
202: Impedance calculation unit
203: Voltage deviation calculation unit
204: Voltage level determination unit
205: Component addition/change unit
301: Random model storage unit
302: Determination condition storage unit
303: Countermeasure component storage unit

1. A power-supply design system comprising:
an input device that inputs design data of an electronic device;
a storage device that stores a random model representing a current fluctuation due to operation/non-operation of each circuit in the electronic device;
a statistical value calculation device that calculates a statistical value representing a power-supply fluctuation in a power supply of the electronic device based on the design data and the random model; and
an output device that outputs the statistical value representing the power-supply fluctuation.

2. The power-supply design system according to claim 1, wherein the statistical value calculation device comprises:
a current deviation calculation unit that calculates a current deviation indicating the current fluctuation in the electronic device based on the design data and the random model;
an impedance calculation unit that calculates an impedance of the power supply based on the design data; and
a voltage deviation calculation unit that calculates a voltage deviation indicating a voltage fluctuation of the power supply as the statistical value representing the power-supply fluctuation based on the current deviation calculated by the current deviation calculation unit and the impedance calculated by the impedance calculation unit.

3. The power-supply design system according to claim 2, further comprising a voltage level determination unit that determines whether or not a voltage fluctuation range of the power supply is in a design level range based on the voltage deviation calculated by the voltage deviation calculation unit, and generates information indicating whether or not the voltage fluctuation range of the power supply is in the design level range as a determination result,
wherein the output device outputs the generated determination result.

4. The power-supply design system according to claim 3, further comprising a component addition/change unit that adds a countermeasure component to a circuit of the power supply or changes a component in the circuit of the power supply to a countermeasure component so that the voltage fluctuation range of the power supply is in the design level range when the voltage fluctuation range of the power supply is not in the design level range,
wherein the output device outputs information on the circuit of the power supply in which addition or change of the countermeasure component is performed.

5. The power-supply design system according to claim 4, wherein the component addition/change unit performs the addition or the change of the countermeasure component based on the impedance calculated by the impedance calculation unit.

6. The power-supply design system according to claim 2, wherein the current deviation calculated by the current deviation calculation unit is a standard deviation of the current fluctuation, and
the voltage deviation calculated by the voltage deviation calculation unit is a standard deviation of the voltage fluctuation.

7. The power-supply design system according to claim 2, wherein the impedance calculation unit generates an equivalent circuit model based on the design data, and calculates the impedance by use of a circuit simulator based on the generated equivalent circuit model.

8. The power-supply design system according to claim 1, wherein the random model is a model under an assumption that the operation/non-operation of each circuit in the electronic device is randomly generated at a constant probability.

9. The power-supply design system according to claim 1, wherein the random model is a model in which current uniformly varies within a range of a given current fluctuation amount.

10. A power-supply design method comprising:
inputting design data of an electronic device;
calculating a statistical value representing a power-supply fluctuation in a power supply of the electronic device based on the design data and a random model representing a current fluctuation due to operation/non-operation of each circuit in the electronic device; and
outputting the statistical value representing the power-supply fluctuation.

11. A program for a power-supply design for causing a computer to execute the power-supply design method of claim 10.
